(19) United States
(12) Patent Application Publication
(10) Pub. No.: US 2025/0337973 A1
(43) Pub. Date: Oct. 30, 2025

(54) IDENTIFYING CANDIDATE MEMBERS FOR A CHANNEL ON A CONTENT PLATFORM

(71) Applicant: Google LLC, Mountain View, CA (US)

(72) Inventors: Briana Yvonne Seiderman, Zurich (CH); Charu Agarwal, Zurich (CH); Martin Krivánek, Thalwil (CH); René Jonathan Vennik, Freienbach (CH); Dhruv Bakshi, Zug (CH)

(21) Appl. No.: 19/195,654

(22) Filed: Apr. 30, 2025

Related U.S. Application Data
(60) Provisional application No. 63/640,486, filed on Apr. 30, 2024.

(51) Int. Cl. H04N 21/266; H04N 21/466; H04N 21/4788

(52) U.S. Cl. CPC H04N 21/266; H04N 21/4668; H04N 21/4788

(57) ABSTRACT

Systems and methods for identifying candidate members for channel memberships for presentation on a content platform are provided. It is determined that a channel membership recommendation is to be provided to a channel owner of a channel. Candidate members for the channel are identified among a plurality of subscribers of the channel, wherein identifying the candidate members for the channel comprises identifying a plurality of engagement signals pertaining to a plurality of subscribers of the channel; determining, for each subscriber of the plurality of subscribers, a respective ranking based on the plurality of engagement signals; and selecting, based on the rankings, a subset of the plurality of subscribers as the candidate members of the channel. A channel user interface (UI) of the content sharing platform is caused to be presented to the channel owner, the channel UI displaying one or more visual representations of respective one or more candidate members.

### RELATED APPLICATIONS

This application claims the benefit of priority from U.S. Provisional Application No. 63/640,486, filed Apr. 30, 2024, which is incorporated herein by reference.

### TECHNICAL FIELD

Aspects and implementations of the present disclosure relate to identifying candidate members for channel memberships for presentation on a content platform.

### BACKGROUND

A platform (e.g., a content platform) can transmit media items to client devices connected to the platform via a network. A media item can include an audio item or a video item, in some instances. Users can consume the transmitted media items via a user interface (UI) provided by the platform. In some instances, media items can be provided to users through channels. A channel can include content provided by a channel owner. A user can subscribe to the channel to gain access to the media items of the channel. In some instances, a channel owner can provide channel memberships, where a user can subscribe to the channel membership and gain access to exclusive (e.g., paid) content.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes determining, by a processing device of a content sharing platform, that a channel membership recommendation is to be provided to a channel owner of a channel. The method further includes identifying, among a plurality of subscribers of the channel, candidate members for the channel, wherein identifying the candidate members for the channel comprises: identifying, by the processing device, a plurality of engagement signals pertaining to the plurality of subscribers; determining, for each subscriber of the plurality of subscribers, a respective ranking based on the plurality of engagement signals; and selecting, based on the rankings, a subset of the plurality of subscribers as the candidate members of the channel. The method further includes causing a channel user interface (UI) of the content sharing platform to be presented to the channel owner, the channel UI displaying one or more visual representations of respective one or more candidate members.

In some implementations, the one or more visual representations do not reveal personal identifying information of respective candidate members.

In some implementations, identifying the plurality of engagement signals comprises performing at least one of: (i) identifying a number of channel interactions associated with a subscriber of the plurality of subscribers; (ii) identifying a period of time that has elapsed since the subscriber of the plurality of subscribers has subscribed to the channel; (iii) identifying a number of channel memberships associated with the subscriber of the plurality of subscribers; or (iv) determining that a visual representation of the subscriber of the plurality of subscribers is customized by the subscriber.

In some implementations, the number of channel interactions comprises one or more of: a number of comments on the channel associated with the subscriber of the plurality of subscribers or a number of likes on the channel associated with the subscriber of the plurality of subscribers.

In some implementations, determining the ranking further comprises: assigning a weight value to each engagement signal of the plurality of engagement signals.

In some implementations, selecting the subset of the plurality of subscribers as the candidate members of the channel further comprises: determining that a ranking of a first subscriber of the plurality of subscribers satisfies a threshold criterion; and selecting the first subscriber of the plurality of subscribers as a candidate member of the channel.

In some implementations, the one or more visual representations of respective one or more candidate members are displayed on the channel UI in a random order.

In some implementations, the method further includes removing a subscriber of the plurality of subscribers from the selected candidate members based on metadata associated with the subscriber.

In some implementations, the channel UI displays the one or more visual representations of the respective one or more candidate members along with corresponding one or more modified characteristics of the channel.

An aspect of the disclosure provides a system including a memory device and a processing device communicatively coupled to the memory device. The processing device performs operations including determining that a channel membership recommendation is to be provided to a channel owner of a channel of a content sharing platform. The processing device is to perform operations further including identifying, among a plurality of subscribers of the channel, candidate members for the channel, wherein identifying the candidate members for the channel comprises: identifying a plurality of engagement signals pertaining to the plurality of subscribers; determining, for each subscriber of the plurality of subscribers, a respective ranking based on the plurality of engagement signals; and selecting, based on the rankings, a subset of the plurality of subscribers as the candidate members of the channel. The processing device is to perform operations further including causing a channel user interface (UI) of the content sharing platform to be presented to the channel owner, the channel UI displaying one or more visual representations of respective one or more candidate members.

In some implementations, the one or more visual representations do not reveal personal identifying information of respective candidate members.

In some implementations, identifying the plurality of engagement signals further comprises performing at least one of: (i) identifying a number of channel interactions associated with a subscriber of the plurality of subscribers; (ii) identifying a period of time that has elapsed since the subscriber of the plurality of subscribers has subscribed to the channel; (iii) identifying a number of channel memberships associated with the subscriber of the plurality of subscribers; or (iv) determining that a visual representation of the subscriber of the plurality of subscribers is customized by the subscriber.

In some implementations, the number of channel interactions comprises one or more of: a number of comments on the channel associated with the subscriber of the plurality of subscribers or a number of likes on the channel associated with the subscriber of the plurality of subscribers.

In some implementations, determining the ranking further comprises: assigning a weight value to each engagement signal of the plurality of engagement signals.

In some implementations, selecting the subset of the plurality of subscribers as the candidate members of the channel further comprises: determining that a ranking of a first subscriber of the plurality of subscribers satisfies a threshold criterion; and selecting the first subscriber of the plurality of subscribers as a candidate member of the channel.

In some implementations, the one or more visual representations of respective one or more candidate members are displayed on the channel UI in a random order.

In some implementations, the processing device is to perform operations further including removing a subscriber of the plurality of subscribers from the selected candidate members based on metadata associated with the subscriber.

In some implementations, the channel UI displays the one or more visual representations of the respective one or more candidate members along with corresponding one or more modified characteristics of the channel.

An aspect of the disclosure provides a computer program including instructions that, when the program is executed by a processing device, cause the processing device to perform operations including determining that a channel membership recommendation is to be provided to a channel owner of a channel of a content sharing platform. The processing device is to perform operations further including identifying, among a plurality of subscribers of the channel, candidate members for the channel, wherein identifying the candidate members for the channel comprises: identifying a plurality of engagement signals pertaining to the plurality of subscribers of the channel; determining, for each subscriber of the plurality of subscribers, a respective ranking based on the plurality of engagement signals; and selecting, based on the rankings, a subset of the plurality of subscribers as the candidate members of the channel. The processing device is to perform operations further including causing a channel user interface (UI) of the content sharing platform to be presented to the channel owner, the channel UI displaying one or more visual representations of respective one or more candidate members.

In some implementations, the one or more visual representations do not reveal personal identifying information of respective candidate members.

In some implementations, identifying the plurality of engagement signals further comprises performing at least one of: (i) identifying a number of channel interactions associated with a subscriber of the plurality of subscribers; (ii) identifying a period of time that has elapsed since the subscriber of the plurality of subscribers has subscribed to the channel; (iii) identifying a number of channel memberships associated with the subscriber of the plurality of subscribers; or (iv) determining that a visual representation of the subscriber of the plurality of subscribers is customized by the subscriber.

In some implementations, the number of channel interactions comprises one or more of: a number of comments on the channel associated with the subscriber of the plurality of subscribers or a number of likes on the channel associated with the subscriber of the plurality of subscribers.

In some implementations, determining the ranking further comprises: assigning a weight value to each engagement signal of the plurality of engagement signals.

In some implementations, selecting the subset of the plurality of subscribers as the candidate members of the channel further comprises: determining that a ranking of a first subscriber of the plurality of subscribers satisfies a threshold criterion; and selecting the first subscriber of the plurality of subscribers as a candidate member of the channel.

In some implementations, the one or more visual representations of respective one or more candidate members are displayed on the channel UI in a random order.

In some implementations, the processing device is to perform operations further including removing a subscriber of the plurality of subscribers from the selected candidate members based on metadata associated with the subscriber.

In some implementations, the channel UI displays the one or more visual representations of the respective one or more candidate members along with corresponding one or more modified characteristics of the channel.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of a method for identifying candidate members for channel memberships for presentation on a content platform, in accordance with implementations of the present disclosure.

FIG. 3 is a block diagram illustrating an example channel user interface (UI) displaying a visual representation of selected candidate members for a channel membership and corresponding one or more modified characteristics of a channel, in accordance with implementations of the present disclosure.

FIG. 4 is a block diagram illustrating an exemplary computer system, in accordance with implementations of the present disclosure.

### DETAILED DESCRIPTION

Aspects of the present disclosure relate to identifying candidate members for channel memberships for presentation on a content platform.

A platform (e.g., a content platform) can transmit media items to client devices connected to the platform via a network. A media item can include an audio item or a video item, in some instances. Users can consume the transmitted media items via a user interface (UI) provided by the platform. In some instances, media items can be provided to users through channels.

A channel can include content available from a common source and/or having a common topic or theme. A channel can be managed by the channel owner who can perform various management actions on the channel. Management actions may include, for example, adding media items to the channel, removing media items from the channel, defining subscription requirements for the channel, defining presentation attributes for channel content, defining access attributes for channel content, etc. The channel content can include media items uploaded to the content platform by the channel owner and/or media items selected by the channel owner from content available on the content platform. A channel owner can be, e.g., a professional content provider (e.g., a professional content creator, a professional content distributor, a content rental service, a television (TV) service, etc.) or an amateur individual. The channel content can include, e.g., professional content (e.g., movie clips, TV clips, music videos, educational videos) and/or amateur content (e.g., video blogging, short original videos, etc.).

Users of the platform can subscribe to one or more channels in which they are interested. Typically, subscribing to a channel provides users with free access to content on the channel. In some instances, a channel owner may be interested in monetizing the channel by making some or all of the content on the channel available to users who have a paid subscription to the channel (e.g., a channel membership). However, the channel owner may not be aware of the benefits to the channel and/or the channel owner by providing a paid subscription channel, such as increased revenue, increased viewership, etc.

Implementations of the present disclosure address the above and other deficiencies by identifying and presenting to the channel owner candidate members for the channel, assuming that the channel owner may be more likely to provide channel membership to subscribers when presented with a recommendation that shows a list of candidate members. In some implementations, the candidate members can be selected from a set of subscribers of the channel, assuming that the channel owner may recognize at least some of the channel subscriber avatars and will be more likely to provide channel membership to those subscribers.

In some implementations, the set of subscribers can be ranked based on a set of signals that characterize the degree of engagement of a subscriber with the channel. The highest ranking (and thus most engaged) subscribers can be selected as candidate members.

The selected candidate members can be presented to the channel owner via the channel UI. For example, the channel UI can display a visual representation (“avatar”) of each candidate member of the one or more candidate members. Such a visual representation may safeguard the privacy of the user by not revealing any personal identifying information or the real identity of the user. Furthermore, in some implementations, a user can opt out from being selected as a candidate channel member. In some implementations, the channel UI can display the visual representation of each candidate member in a pseudo-random order thus not revealing any information that can be used to identify individual characteristics of a particular user.

In some implementations, the recommendation to provide channel membership can further illustrate how certain characteristics of the channel are expected to change in response to provision of channel membership (e.g., increased revenue, increased content and/or channel viewership, etc.).

Aspects of the present disclosure provide technical advantages over previous solutions. Aspects of the present disclosure can provide an automated tool for identifying candidate members for a particular channel. The automated tool can take into account the engagement signals of the existing subscribers of the channel. Such an automated tool can be integrated into various services, such as content platforms. Furthermore, encouraging the channel owner to provide channel membership to subscribers can result in longer user sessions, higher user interaction rates, etc., on the content platform.

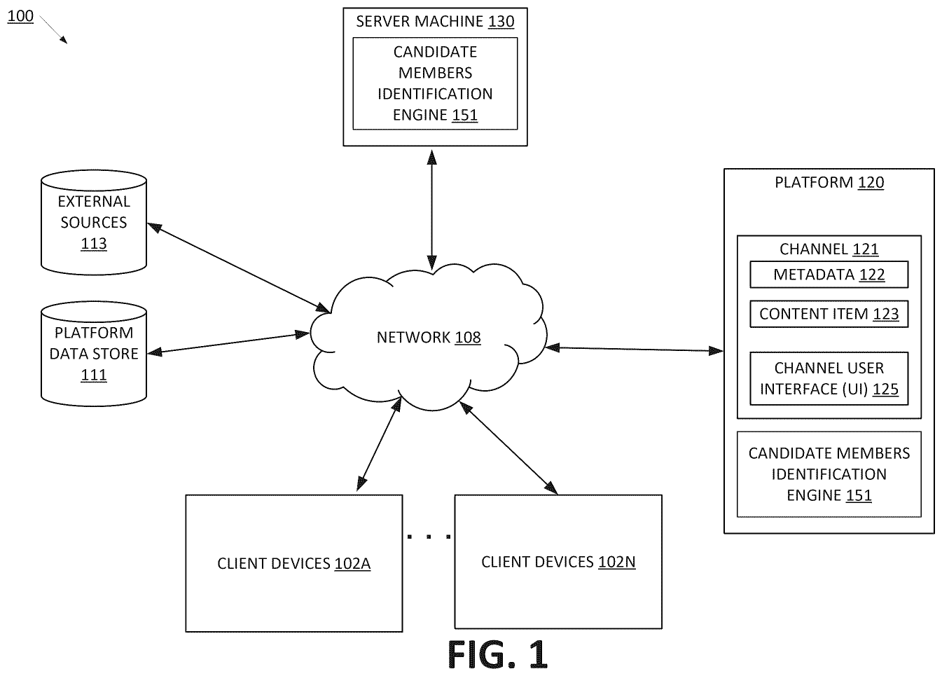

FIG. 1 illustrates an example system 100, in accordance with implementations of the present disclosure. The system 100 includes user devices 102A-N, a platform data store 111, a platform 120, and/or server machine 130, each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, platform data store 111 can be a persistent storage capable of storing data as well as data structures to tag, organize, and index the platform data. In some implementations, a data item of platform data can correspond to one or more portions of a content item for display to a content viewer via a graphical user interface (GUI) on a viewing user device 102, in accordance with implementations described herein. A data item can correspond to metadata for a content item, such as a content item title, transcript, description, length, or content item viewing statistics. In some implementations, a data item of platform data can correspond to one or more portions of a channel, including channel metadata such as a channel title, channel description, channel uploading user, or channel viewing statistics. Platform data store 111 can be hosted by one or more storage devices, such as main memory, magnetic or optical storage-based disks, tapes or hard drives, NAS, SAN, and so forth. In some implementations, platform data store 111 can be a network-attached file server, while in other implementations the platform data store 111 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smartphones, tablet computers, netbook computers, network-connected televisions, etc. Each client device 102 can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital content items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital content items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers can be embedded media players that are embedded in web pages provided by the platform 120.

Platform 120 can include one or more channels 121. A channel 121 can include metadata 122 associated with the channel 121, and one or more content items 123 available from a common source, or content items 123 having a common topic, theme, or substance. Metadata 122 can include various information pertinent to the channel 121, such as a title, description, date, usage statistics, or content language. In some implementations, metadata 122 can include information about the one or more content items 123 of channel 121. For example, metadata 122 can include information about content item 123, such as a title, description, date, identity of channel owner, usage statistics, or language.

A channel 121 can represent one or more content item 123 (e.g., digital content) chosen by a user, digital content made available by a user, digital content uploaded by a user, digital content chosen by a content provider, digital content chosen by a broadcaster, etc. For example, a channel X can include videos Y and Z. A channel can be associated with a channel owner, who is a user that can perform actions on the channel. Different activities can be associated with the channel 121 based on the channel owner's actions, such as the channel owner making digital content available on the channel 121, the channel owner selecting (e.g., liking) digital content associated with another channel 121, the channel owner commenting on digital content associated with another channel 121, etc. The activities associated with the channel 121 can be collected into an activity feed for the channel 121. Users, other than the owner of the channel 121, can subscribe to one or more channels 121 in which they are interested. The concept of “subscribing” may also be referred to as “liking,” “following,” “friending,” and so on.

A content item 123 can be consumed via the Internet or via a mobile device application, such as a content viewer of viewing client devices 102A-N. In some implementations, a content item 123 can correspond to a media file (e.g., a video file, an audio file, a video stream, an audio stream, etc.). In other or similar implementations, a content item 123 can correspond to a portion of a media file (e.g., a portion or a chunk of a video file, an audio file, etc.). As discussed previously, a content item 123 can be requested for presentation to the user by the user of the platform 120. As used herein, “content item” can include an electronic file that can be executed or loaded using software, firmware or hardware configured to digitally present the content item to an entity. As indicated above, in at least one implementation, the platform 120 can store the content items 123, or references to the content items 123, using the platform data store 111. In some implementations, the platform 120 can store the content item 123 or fingerprints as electronic files in one or more formats using platform data store 111.

In some implementations, content item 123 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some implementations, a video item can be stored (e.g., at platform data store 111) as a video file that includes a video component and an audio component. The video component can include video data that corresponds to one or more sequential video frames of the video item. The audio component can include audio data that corresponds to the video data.

In some implementations, platform 120 and/or server machine 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. Platform 120 can include channel 121. Channel 121 can be made accessible through platform 120. In some implementations, platform 120 can facilitate the access of channel 121, or information about channel 121 through channel user interface (UI) 125.

In some implementations, the functions of server machine 130 or platform 120 may be provided by a fewer number of machines. For example, in some implementations, the server machine 130 can be integrated into platform 120. In some implementations, the server machine 130 can be integrated separately from platform 120. In addition, the functionality attributed to a specific component can be performed by different or multiple components operating together. Platform 120 can also be accessed as a service provided to other systems or devices through appropriate application programming interfaces, and thus is not limited to use in websites.

In situations in which the systems discussed here collect personal information about users, or may make use of personal information, the users may be provided with an opportunity to control whether platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the platform 120 and/or server 130.

In various implementations of the disclosure, a “user” can be represented by a single individual. However, other implementations of the disclosure encompass a “user” being an entity controlled by a group of individuals and/or an automated source. For example, a group of individuals federated as a community in a social network can be considered a “user.” Further to the descriptions above, a user can be provided with controls allowing the user to make an election as to both if and when systems, programs, or features described can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user. As noted herein above, in some implementations, the selected candidate channel members are presented to the channel owner by their respective visual representations (“avatars”) which do not reveal their real identities or any other personal identifying information. In some implementations, a user can opt out from being selected as a candidate channel member.

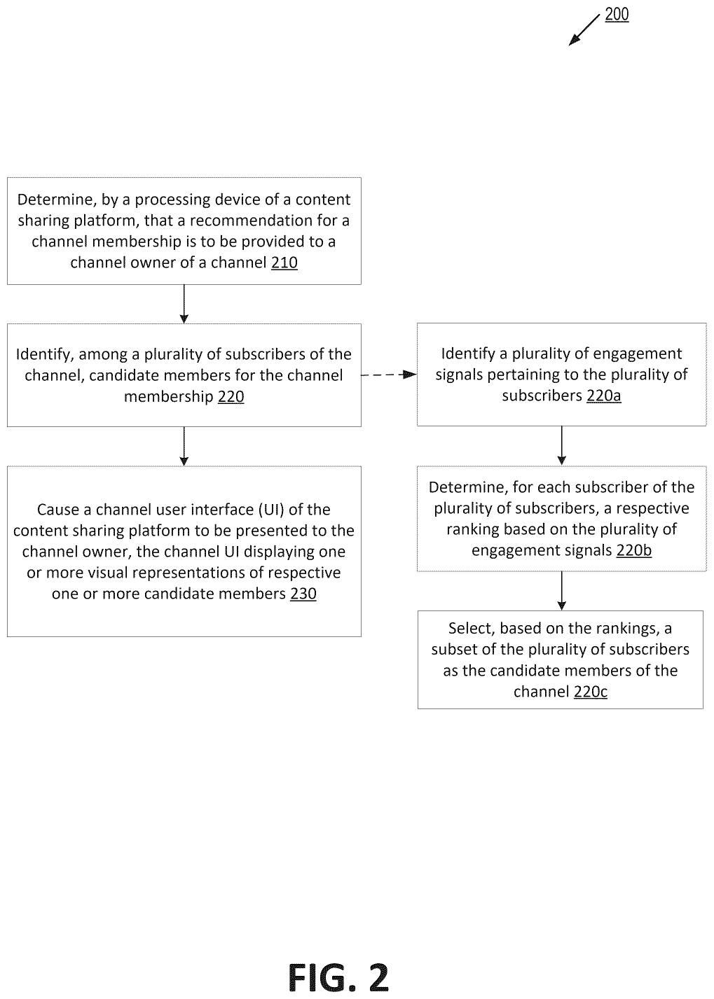

FIG. 2 depicts a flow diagram of a method for identifying candidate members for channel memberships for presentation on a content platform, in accordance with implementations of the present disclosure. Method 200 may be performed by processing logic that may include hardware (circuitry, dedicated logic, etc.), software (e.g., instructions run on a processing device), or a combination thereof. In one implementation, some or all the operations of method 200 may be performed by one or more components of system 100 of FIG. 1 (e.g., platform 120, server(s) 130, and/or candidate members identification engine 151).

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 210, the processing logic determines that a channel membership recommendation is to be provided to a channel owner of a channel of a content platform (e.g., platform 120 of FIG. 1). In some implementations, the channel can be associated with content items (e.g., content item 123 of FIG. 1) and/or metadata (e.g., metadata 122 of FIG. 1). In some implementations, the processing logic determines that the channel membership recommendation is to be provided to the channel owner in response to identifying that the channel does not have any members and thus is not a paid subscription channel. Such a determination can be made based on the metadata associated with the channel (e.g., the metadata 122 of FIG. 1) and/or other data that can be retrieved, e.g., from the platform data store 111 of FIG. 1. In some implementations, the processing logic determines that the recommendation for the channel membership is to be provided to the channel owner in response to receiving a request (e.g., from the channel owner).

At block 220, the processing logic identifies, among the subscribers of the channel, a subset of candidate members for the channel. In some implementations, the operations of block 220 can further include operations of blocks 220A-220C.

At block 220A, the processing logic identifies a set of engagement signals pertaining to the set of subscribers of the channel. For example, the processing logic can retrieve the set of engagement signals from a data store associated with the platform 120 (e.g., the platform data store 111 of FIG. 1). In an illustrative example, the set of engagement signals can include the number of channel interactions by a subscriber of the set of subscribers (e.g., a number of “comments” (e.g., responses, posts, etc.) made by the subscriber on the channel and/or a number of “likes” (e.g., reactions) made by the subscriber on the channel). In another illustrative example, the set of engagement signals can include the subscription age, which is the period of time (e.g., hours, days, etc.) that has elapsed since a subscriber has subscribed to the channel. In another illustrative example, the set of engagement signals can include the number of other channel memberships that a subscriber of the set of subscribers has. In another illustrative example, the set of engagement signals can include a flag indicating whether a subscriber of the set of subscribers has a visual representation (e.g., an avatar) that has been customized by the subscriber.

At block 220B, the processing logic can determine, for each subscriber of the plurality of subscribers of the channel, a respective ranking based on the identified engagement signals. For example, the processing logic can assign a weight value to each engagement signal of the set of engagement signals. For example, the processing logic can assign the highest weight value to the visual representation-based engagement signal (e.g., a flag indicating whether a subscriber has a visual representation that has been customized by the subscriber). In some implementations, the processing logic can assign the second highest weighted value to the subscription age-based engagement signal.

Upon assigning the weight values to each engagement signal of the set of engagement signals, the processing logic can rank each subscriber of the set of subscribers according to the weighted values of respective engagement signals. For example, the processing logic can compute the ranking value of a subscriber as a weighted sum of the values of the chosen engagement signals for the subscriber.

At block 220C, the processing logic can utilize the subscriber rankings to select the candidate members for the channel. In an illustrative example, the processing logic can select a predefined number of the highest ranking subscribers of a channel as the candidate members for the channel. In another illustrative example, the processing logic can select at least a subset of subscribers whose ranking values satisfy a predefined criterion (e.g., exceed a threshold ranking value). In another illustrative example, the processing logic can randomly select, among subscribers whose ranking values satisfy a predefined criterion (e.g., exceed a threshold ranking value), a predefined number of subscribers. In some implementations, the processing logic can exclude certain subscribers from being selected as candidate members. In an illustrative example, excluding a subscriber from being selected as a candidate member can be based on metadata associated with the subscriber. Such metadata can reflect, e.g., the subscriber preferences, thus allowing the subscriber to opt out from being selected as a candidate member. In some implementations, the processing logic can retrieve the metadata characteristic associated with the subscriber from a data store (e.g., the platform data store 111 of FIG. 1).

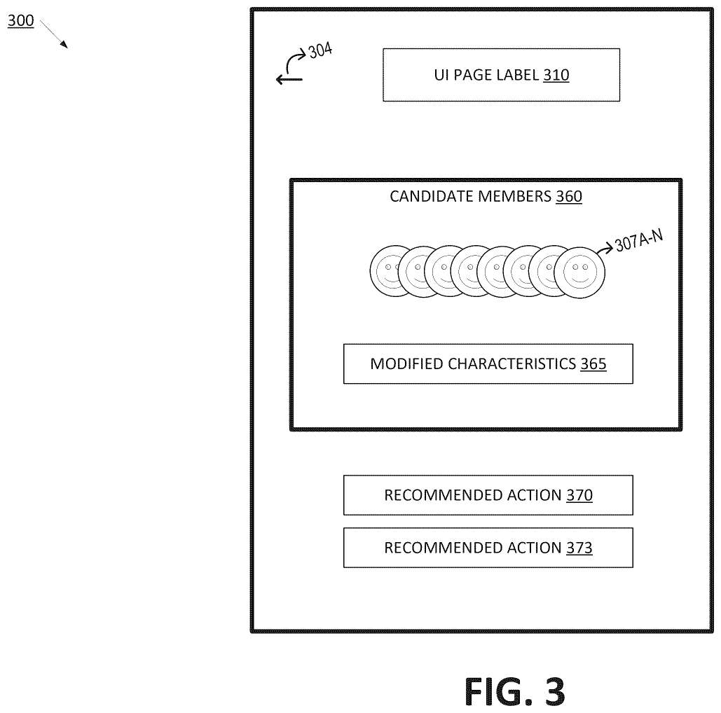

At block 230, the processing logic causes a channel user interface (UI) of the content sharing platform (e.g., the channel UI 125 of FIG. 1 and/or channel UI 300 of FIG. 3) to be presented to the channel owner. The channel UI can display the visual representations (e.g., avatars) of at least a subset of the selected candidate members for the channel. Using the visual representations may safeguard the privacy of the users by not revealing any personal identifying information or the real identities of the user. In some implementations, the channel UI can display the visual representation of each candidate member in a pseudo-random order thus not revealing any information that can be used to identify individual characteristics of a particular user.

In some implementations, channel user interface can further display certain characteristics of the channel and their expected changes in response to provision of channel membership (e.g., increased revenue, increased content and/or channel viewership, etc.).

In an illustrative example, referring to FIG. 3, the processing logic can cause the channel UI 300 to be presented to the channel owner. The channel UI 300 can include a UI page label 310 (e.g., an identifier of the UI page, such as “Channel Memberships,” “Memberships,” etc.), a UI element 304 (e.g., a back button that can be selectable to go back to a previous page in the channel UI 300, a display area for the subset of the list of candidate members 360, a visual representation 307A-N for each candidate member in the subset of the list of candidate members 360, one or more modified characteristics 365 (e.g., one or more textual descriptions of the expected increased revenue and/or expected increased viewership for the channel if the channel owner provided the channel membership), and/or a display area to provide one or more recommended actions 370, 373 to the channel owner pertaining to providing channel memberships and/or learning more about channel memberships (e.g., “Get started” with channel memberships, “Find out more” about channel memberships, etc.). In some implementations, the one or more recommended actions 370, 373 can be UI elements that are selectable (e.g., by the channel owner).

FIG. 3 is a block diagram illustrating an example channel user interface (UI) displaying a visual representation of selected candidate members for a channel membership and corresponding one or more modified characteristics of a channel, in accordance with implementations of the present disclosure. FIG. 3 is described with respect to FIG. 2 herein above.

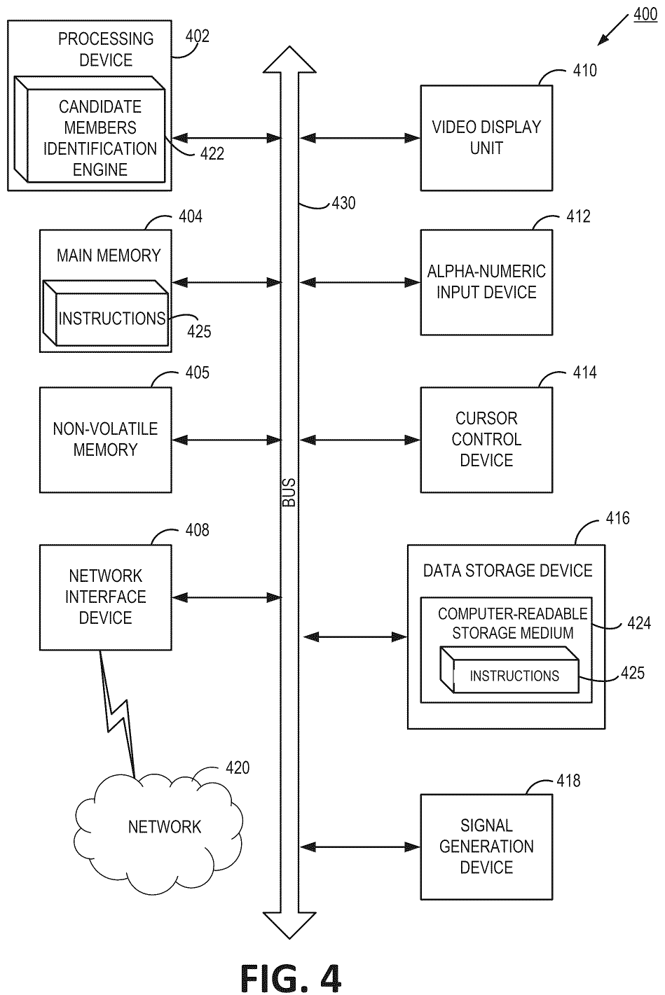

FIG. 4 is a block diagram illustrating an exemplary computer system, in accordance with implementations of the present disclosure. The computer system 400 can be the server 130, 133, and/or 150 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 440.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 405 (e.g., identifying candidate members for channel memberships for presentation on a content platform) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 420 (e.g., a speaker).

The data storage device 418 can include a non-transitory machine-readable storage medium 424 (also computer-readable storage medium) on which is stored one or more sets of instructions 405 (e.g., for identifying candidate members for channel memberships for presentation on a content platform) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 430 via the network interface device 408.

In one implementation, the instructions 405 include instructions for identifying candidate members for channel memberships for presentation on a content platform. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
determining, by a processing device of a content sharing platform, that a channel membership recommendation is to be provided to a channel owner of a channel;
identifying, among a plurality of subscribers of the channel, candidate members for the channel, wherein identifying the candidate members for the channel comprises:
identifying a plurality of engagement signals pertaining to the plurality of subscribers of the channel;
determining, for each subscriber of the plurality of subscribers, a respective ranking based on the plurality of engagement signals; and
selecting, based on the rankings, a subset of the plurality of subscribers as the candidate members of the channel; and
causing a channel user interface (UI) of the content sharing platform to be presented to the channel owner, the channel UI displaying one or more visual representations of respective one or more candidate members.

2. The method of claim 1, wherein the one or more visual representations do not reveal personal identifying information of respective candidate members.

3. The method of claim 1, wherein identifying the plurality of engagement signals further comprises performing at least one of:
(i) identifying a number of channel interactions associated with a subscriber of the plurality of subscribers;
(ii) identifying a period of time that has elapsed since the subscriber of the plurality of subscribers has subscribed to the channel;
(iii) identifying a number of channel memberships associated with the subscriber of the plurality of subscribers; or
(iv) determining that a visual representation of the subscriber of the plurality of subscribers is customized by the subscriber.

4. The method of claim 2, wherein the number of channel interactions comprises one or more of: a number of comments on the channel associated with the subscriber of the plurality of subscribers or a number of likes on the channel associated with the subscriber of the plurality of subscribers.

5. The method of claim 1, wherein determining the ranking further comprises:
assigning a weight value to each engagement signal of the plurality of engagement signals.

6. The method of claim 1, wherein selecting the subset of the plurality of subscribers as the candidate members of the channel further comprises:
determining that a ranking of a first subscriber of the plurality of subscribers satisfies a threshold criterion; and
selecting the first subscriber of the plurality of subscribers as a candidate member of the channel.

7. The method of claim 1, wherein the one or more visual representations of respective one or more candidate members are displayed on the channel UI in a random order.

8. The method of claim 1, further comprising:
removing a subscriber of the plurality of subscribers from the selected candidate members based on metadata associated with the subscriber.

9. The method of claim 1, wherein the channel UI displays the one or more visual representations of the respective one or more candidate members along with corresponding one or more modified characteristics of the channel.

10. A system comprising:
a memory device; and
a processing device coupled to the memory device, the processing device to perform operations comprising:
determining that a channel membership recommendation is to be provided to a channel owner of a channel;
identifying, among a plurality of subscribers of the channel, candidate members for the channel, wherein identifying the candidate members for the channel comprises:
identifying a plurality of engagement signals pertaining to the plurality of subscribers of the channel;
determining, for each subscriber of the plurality of subscribers, a respective ranking based on the plurality of engagement signals; and
selecting, based on the rankings, a subset of the plurality of subscribers as the candidate members of the channel; and
causing a channel user interface (UI) of the content sharing platform to be presented to the channel owner, the channel UI displaying one or more visual representations of respective one or more candidate members.

11. The system of claim 10, wherein the one or more visual representations do not reveal personal identifying information of respective candidate members.

12. The system of claim 10, wherein to identify the plurality of engagement signals, the processing device is to perform operations further comprising:
(i) identifying a number of channel interactions associated with a subscriber of the plurality of subscribers;
(ii) identifying a period of time that has elapsed since the subscriber of the plurality of subscribers has subscribed to the channel;
(iii) identifying a number of channel memberships associated with the subscriber of the plurality of subscribers; or
(iv) determining that a visual representation of the subscriber of the plurality of subscribers is customized by the subscriber.

13. The system of claim 12, wherein the number of channel interactions comprises one or more of: a number of comments on the channel associated with the subscriber of the plurality of subscribers or a number of likes on the channel associated with the subscriber of the plurality of subscribers.

14. The system of claim 10, wherein the channel UI displays the one or more visual representations of the respective one or more candidate members along with corresponding one or more modified characteristics of the channel.

15. A non-transitory computer readable storage medium comprising instructions for a server that, when executed by a processing device, cause the processing device to perform operations comprising:
determining that a channel membership recommendation is to be provided to a channel owner of a channel;
identifying, among a plurality of subscribers of the channel, candidate members for the channel, wherein identifying the candidate members for the channel comprises:
identifying a plurality of engagement signals pertaining to the plurality of subscribers of the channel;
determining, for each subscriber of the plurality of subscribers, a respective ranking based on the plurality of engagement signals; and
selecting, based on the rankings, a subset of the plurality of subscribers as the candidate members of the channel; and
causing a channel user interface (UI) of the content sharing platform to be presented to the channel owner, the channel UI displaying one or more visual representations of respective one or more candidate members.

16. The non-transitory computer readable storage medium of claim 15, wherein the one or more visual representations do not reveal personal identifying information of respective candidate members.

17. The non-transitory computer readable storage medium of claim 15, wherein to identify the plurality of engagement signals, the processing device is to perform operations further comprising:
(i) identifying a number of channel interactions associated with a subscriber of the plurality of subscribers;
(ii) identifying a period of time that has elapsed since the subscriber of the plurality of subscribers has subscribed to the channel;
(iii) identifying a number of channel memberships associated with the subscriber of the plurality of subscribers; or
(iv) determining that a visual representation of the subscriber of the plurality of subscribers is customized by the subscriber.

18. The non-transitory computer readable storage medium of claim 17, wherein the number of channel interactions comprises one or more of: a number of comments on the channel associated with the subscriber of the plurality of subscribers or a number of likes on the channel associated with the subscriber of the plurality of subscribers.

19. The non-transitory computer readable storage medium of claim 15, wherein to select the subset of the plurality of subscribers as the candidate members of the channel, the processing device is to perform operations further comprising:
determining that a ranking of a first subscriber of the plurality of subscribers satisfies a threshold criterion; and
selecting the first subscriber of the plurality of subscribers as a candidate member of the channel.

20. The non-transitory computer readable storage medium of claim 15, wherein the channel UI displays the one or more visual representations of the respective one or more candidate members along with corresponding one or more modified characteristics of the channel.
